(19) United States
(12) Patent Application Publication
(10) Pub. No.: US 2023/0143133 A1
(43) Pub. Date: May 11, 2023

(54) INTELLIGENTLY ENHANCING MEDIA CONTENT ITEMS

(71) Applicant: Meta Platforms, Inc., Menlo Park, CA (US)

(72) Inventors: Kirollos Risk, Walnut Creek, CA (US); Bruno Pereira Evangelista, San Carlos, CA (US); Alexandra Louise Krakaris, Lafayette, CA (US); Kenta Onimura, Torrance, CA (US); Mitchell Kogan, San Diego, CA (US)

(21) Appl. No.: 17/523,802

(22) Filed: Nov. 10, 2021

(51) Int. Cl. H04N 21/431

(52) U.S. Cl. CPC H04N 21/4312

(57) ABSTRACT

Methods, systems, and storage media for intelligently enhancing media content items are disclosed. Exemplary implementations may: present a user interface for initiating creation of media content items within a media sharing application running on a media capture device, the user interface including one or more selectable media capture modes; receive a selection of one of the selectable media capture mode(s), the one of the selectable media capture mode(s) being configured to intelligently enhance the media content items; receive a plurality of signals from the media capture device and/or the media sharing application; determine at least one enhancement to apply to a captured media content item based upon at least a portion of the plurality of signals; receive a captured media content item; automatically apply the enhancement(s) to the captured media content item to create an enhanced media content item, and cause display of the enhanced media content item in a media preview window of the media sharing application.

### TECHNICAL FIELD

The present disclosure generally relates to visual media. More particularly, the present disclosure relates to intelligently enhancing captured media content items.

### BACKGROUND

Media sharing and media sharing applications have become a mainstream way for people to keep in touch and apprised of what their friends and families are engaged in. With most mobile communication devices having image and/or video capture capabilities, and with the quantity of applications available that permit the sharing of media content items, this means of communications has garnered a wide audience. Accordingly, both novice and experienced photographers, videographers, and photo/video editors are becoming frequent users of media sharing technologies.

### BRIEF SUMMARY

The subject disclosure provides for systems and methods for intelligently enhancing captured media content items. Selection of a media capture mode configured for intelligently enhancing captured media content items may be received (e.g., from a user interface presented in association with a media sharing application running on a device capable of capturing media content items). One or more signals may be received from the media capture device and/or the media sharing application, the signal(s) including ambient and/or personalized information that may be utilized to enhance captured media content items. Based upon at least a portion of the received signal(s), one or more enhancements may be intelligently determined for application to a captured media content item. Once a captured media content item is received, the determined enhancement(s) may be applied to the captured media content item to create an enhanced media content item. The enhanced media content item may be displayed, for instance, in a preview window of the media sharing application.

One aspect of the present disclosure relates to a method for intelligently enhancing captured media content items. The method may include presenting a user interface for initiating creation of media content items within a media sharing application running on a media capture device, the user interface including one or more selectable media capture modes. The method may include receiving a selection of one of the one or more selectable media capture modes, the one of the one or more selectable media capture modes being configured to intelligently enhance media content items. The method may include receiving a plurality of signals from at least one of the media capture device and the media sharing application. The method may include intelligently determining at least one enhancement to apply to a captured media content item based upon at least a portion of the plurality of signals. The method may include receiving the captured media content item. The method may include applying the at least one enhancement to the captured media content item to create an enhanced media content item. The method may include causing display of the enhanced media content item, for instance, in a media preview window of the media sharing application.

Another aspect of the present disclosure relates to a system configured for intelligently enhancing captured media content items. The system may include one or more hardware processors configured by machine-readable instructions. The processor(s) may be configured to present a user interface for initiating creation of media content items within a media sharing application running on a media capture device, the user interface including one or more selectable media capture modes. The processor(s) may be configured to receive a selection of one of the one or more selectable media capture modes, the one of the one or more selectable media capture modes being configured to intelligently enhance media content items. The processor(s) may be configured to receive a plurality of signals from at least one of the media capture device and the media sharing application. The processor(s) may be configured to intelligently determine at least one enhancement to apply to a captured media content item based upon at least a portion of the plurality of signals. The processor(s) may be configured to receive the captured media content item. The processor(s) may be configured to apply the at least one enhancement to the captured media content item to create an enhanced media content item. The processor(s) may be configured to cause display of the enhanced media content item, e.g., in a media preview window of the media sharing application.

Yet another aspect of the present disclosure relates to a non-transient computer-readable storage medium having instructions embodied thereon, the instructions being executable by one or more processors to perform a method for intelligently enhancing media content items. The method may include presenting a user interface for initiating creation of media content items within a media sharing application running on a media capture device, the user interface including one or more selectable media capture modes. The method may include receiving a selection of one of the one or more selectable media capture modes, the one of the one or more selectable media capture modes being configured to intelligently enhance media content items. The method may include receiving a plurality of signals from at least one of the media capture device and the media sharing application. The method may include intelligently determining at least one enhancement to apply to a captured media content item based upon at least a portion of the plurality of signals. The method may include receiving the captured media content item. The method may include applying the at least one enhancement to the captured media content item to create an enhanced media content item. The method may include causing display of the enhanced media content item, e.g., in a media preview window of the media sharing application.

Still another aspect of the present disclosure relates to a system configured for intelligently enhancing media content items. The system may include means for presenting a user interface for initiating creation of media content items within a media sharing application running on a media capture device, the user interface including one or more selectable media capture modes. The system may include means for receiving a selection of one of the one or more selectable media capture modes, the one of the one or more selectable media capture modes being configured to intelligently enhance media content items. The system may include means for receiving a plurality of signals from at least one of the media capture device and the media sharing application. The system may include means for intelligently determining at least one enhancement to apply to a captured media content item based upon at least a portion of the plurality of signals. The system may include means for receiving the captured media content item. The system may include means for applying the at least one enhancement to the captured media content item to create an enhanced media content item. The system may include means for causing display of the enhanced media content item in a media preview window of the media sharing application.

### BRIEF DESCRIPTION OF THE SEVERAL VIEWS OF THE DRAWINGS

To easily identify the discussion of any particular element or act, the most significant digit or digits in a reference numeral refer to the figure number in which that element is first introduced.

FIG. 1 illustrates a system configured for intelligently creating enhanced media content items, in accordance with one or more implementations.

FIG. 2 is a screen display illustrating a user interface configured for receiving a selection of a media capture mode, according to certain aspects of the disclosure.

FIG. 3 is a screen display illustrating a user interface configured for receiving user acceptance or rejection of an enhanced media content item, according to certain aspects of the disclosure.

FIG. 4A illustrates an exemplary flow diagram for intelligently creating enhanced media content items, according to certain aspects of the disclosure.

FIG. 4B illustrates an exemplary flow diagram for receiving user acceptance or rejection of an enhanced media content item, according to certain aspects of the disclosure.

FIG. 5 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

As previously set forth, media sharing and media sharing applications have become a mainstream way for people to keep in touch and apprised of what their friends and families are engaged in. With most mobile communication devices having image and/or video capture capabilities, and with the quantity of applications that are available that permit media sharing, this means of communications has garnered a wide audience. Accordingly, both novice and experienced photographers, videographers, and photo/video editors are becoming frequent users of media sharing technologies.

While experienced users of media sharing technologies may be familiar with various media content enhancements (e.g., color filters, effects, digital stickers, etc.) that are provided by media capture devices (e.g., mobile communication devices) and/or media sharing applications (e.g., INSTAGRAM), applying such enhancements to captured media content items none-the-less requires a certain amount of input from the user. The friction generated by the required user input is further amplified for the novice user that may be unfamiliar with the enhancements and/or how to apply them. While high quality media content items may be the ultimate goal of all media sharing technology users, current technologies often either provide easy to use, simple enhancements designed to be usable by the masses that result in rudimentary images and/or videos or provide enhancements that are really accessible only by seasoned users willing to spend the time to apply them but result in high quality outputs.

The subject disclosure provides for systems, methods, and computer-readable storage media for intelligently enhancing captured media content items. As used herein, the term “intelligently” means informed based upon signals that are independent of a captured media content item itself. By way of example and not limitation, such signals may be obtained via one or more sensors associated with a media capture device (such signals tending to be related to ambient conditions at the time/place a media content item is being captured) and/or information obtained by a media sharing application (such signals tending to be more personalized to a media capturing user). In some aspects, signals may be based upon items or conditions that are trending in the media sharing application and/or in the ambient environment.

A user interface may be presented for initiating creation of media content items within a media sharing application running on a media capture device, the user interface including one or more selectable media capture modes. A selection of one of the selectable media capture mode(s) may be received. The one of the selectable media capture mode(s) may be configured to intelligently enhance captured media content items. A plurality of signals may be received from the media capture device and/or the media sharing application. At least one enhancement may be intelligently determined for application to a captured media content item based upon at least a portion of the plurality of signals. Upon receipt of a captured media content item, the determined enhancement(s) may be automatically applied (that is, without user selection or input) to the captured media content item to create an enhanced media content item. The enhanced media content item may be displayed, for instance, in a media preview window of the media sharing application.

Aspects of the present disclosure relate to a new paradigm for intelligently creating enhanced media content items. This new paradigm is advantageous because it permits novice users of a media sharing application, as well as experienced users, to share high quality media content items with their respective friends and families. For example, this new paradigm removes the onus of input from the user. In this way, users that are new to a media sharing application do not have the burden of figuring out each potential media content item enhancement that may be applied to a media content item while still taking advantage of the enhancements to media content items that the media capture device and/or media sharing application provide. Further, experienced users may be exposed to enhancements of which they were previously unaware and/or may be able to spend less time and energy creating high quality media content items for sharing.

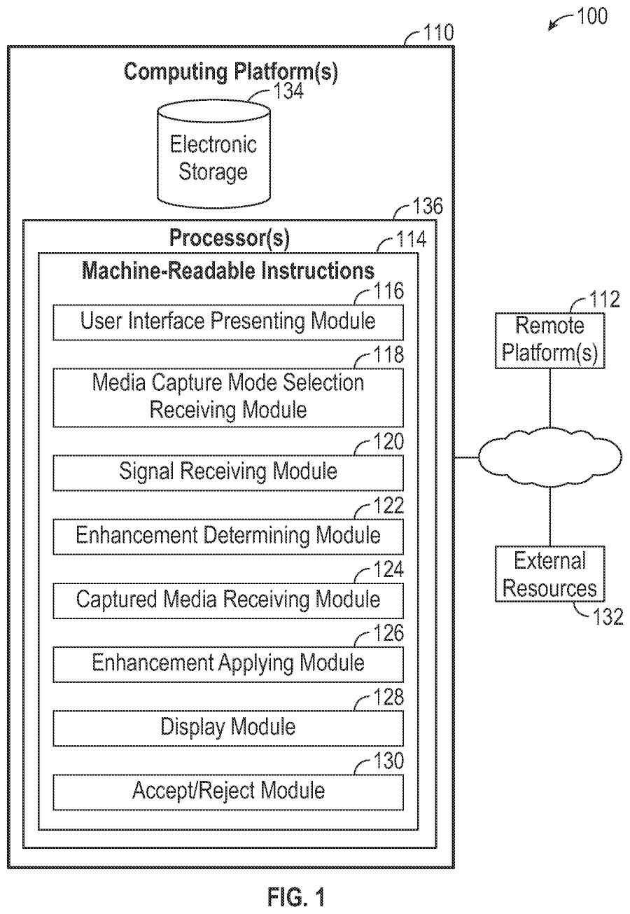

FIG. 1 illustrates a system 100 configured for intelligently creating enhanced media content items, according to certain aspects of the disclosure. In some implementations, system 100 may include one or more computing platforms 110. Computing platform(s) 110 may be configured to communicate with one or more remote platforms 112 according to a client/server architecture, a peer-to-peer architecture, and/or other architectures. Remote platform(s) 112 may be configured to communicate with other remote platforms via computing platform(s) 110 and/or according to a client/server architecture, a peer-to-peer architecture, and/or other architectures. Users may access system 100 via remote platform(s) 112.

Computing platform(s) 110 may be configured by machine-readable instructions 114. Machine-readable instructions 114 may include one or more instruction modules. The instruction modules may include computer program modules. The instruction modules may include one or more of user interface presenting module 116, media capture mode selection receiving module 118, signal receiving module 120, enhancement determining module 122, captured media receiving module 124, enhancement applying module 126, display module 128, accept/reject module 130, and/or other instruction modules.

User interface presenting module 116 may be configured to present a user interface for receiving a user selection of a media capture mode. In aspects, the user interface may be presented within a media sharing application running on a media capture device. In aspects, the user interface may include one or more selectable media capture modes. Exemplary media capture modes may include, without limitation, layout mode, multi-capture mode, boomerang mode, and the like. In aspects, at least one of the one or more selectable media capture modes may be configured to intelligently create enhanced media content items, a more fully described below.

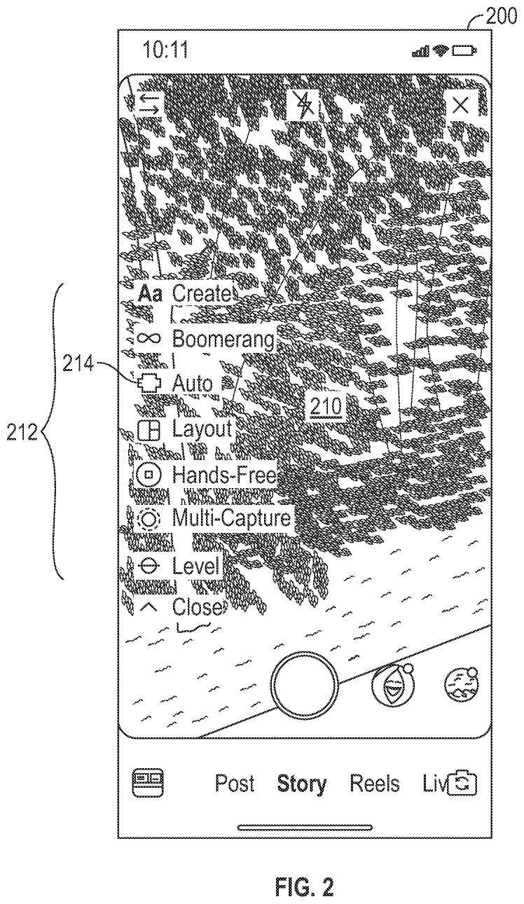

With reference to FIG. 2, a media capture device 200 includes a screen display illustrating a user interface 210 configured for receiving a user selection of a media capture mode, according to certain aspects of the present disclosure. As illustrated, the user interface 210 includes a plurality of media capture modes 212 from which the user may select a desired media capture mode.

Returning to FIG. 1, media capture mode selection receiving module 118 may be configured to receive a selection of one of the one or more selectable media capture modes 212 presented by the user interface presenting module 116. In aspects, the selected one of the one or more selectable media capture modes 212 may be a media capture mode configured to intelligently enhance media content items. With reference back to FIG. 2, one of the plurality of media capture modes 212 shown in the user interface 210, illustrated as reference numeral 214, may be configured for intelligently enhancing media content items.

Signal receiving module 120 of FIG. 1 may be configured to receive a plurality of signals from at least one of the media capture device 200 of FIG. 2 and a media sharing application running on the media capture device. In aspects, the signal receiving module 120 may be configured to receive one or more signals from the media capture device 200. In exemplary implementations of such aspects, the signal(s) received from the media capture device 200 may include an ambient condition signal, a lighting condition signal, a location signal, a time-of-day signal, a scene content signal or content signal (e.g., types of shapes on media (objects, people, landscape, etc.)), and/or a weather signal. In aspects, the signal receiving module 120 may be configured to receive one or more signals from the media sharing application. In implementations of such aspects, the signal(s) received from the media sharing application may include at least one of a signal derived from user profile data, a signal derived from user social connection data, a signal derived from a user social network news feed, a signal derived from a user social network Story, and/or a signal derived from user social network daily stories highlights.

Enhancement determining module 122 may be configured to intelligently determine at least one enhancement to apply to a captured media content item based on at least a portion of the plurality of signals. In aspects, the at least one enhancement may include application of a color filter to the captured media content item. In aspects, the at least one enhancement may include application of an effect to the captured media content item. In aspects, the at least one enhancement may include application of a sticker layered atop the captured media content item. In aspects, the at least one enhancement may include application of an Augmented Reality filter. In aspects, the at least one enhancement may include a deep learning/machine learning filter.

Captured media receiving module 124 may be configured to receive the captured media content item. In aspects, the captured media content item may be received by the captured media receiving module 124 from a camera of the media capture device. In aspects, the captured media content item may be received by the captured media receiving module 124 from a camera of the media sharing application. In aspects, the captured media content item may be an image. In aspects, the captured media content item may be a video.

Enhancement applying module 126 may be configured to automatically (i.e., without user intervention or input) apply the at least one enhancement to the captured media content item to create an enhanced media content item. In aspects, the at least one enhancement may include application of a color filter to the captured media content item. In aspects, the at least one enhancement may include application of an effect to the captured media content item. In aspects, the at least one enhancement may include application of a sticker layered atop the captured media content item. In aspects, the at least one enhancement may include application of an Augmented Reality filter. In aspects, the at least one enhancement may include a deep learning/machine learning filter.

Display module 128 may be configured to cause display of the enhanced media content item. Display module 128 further may be configured to cause display of a user selectable option to accept the application of the at least one enhancement to the captured media content item and a user selectable option to reject the application of the at least one enhancement to the captured media content item. In aspects, display module 128 may be configured to cause display of a user selectable option to accept a portion of the at least one enhancement and reject a portion of the at least one enhancement.

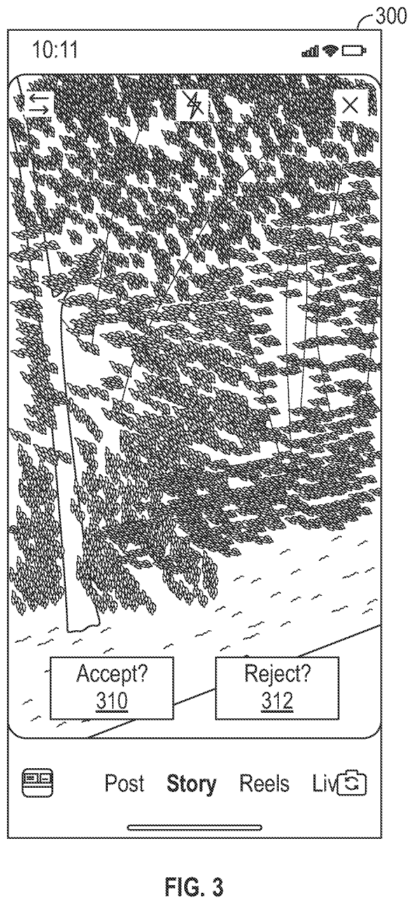

Turning to FIG. 3, a screen display is shown illustrating a user interface 300 configured for receiving acceptance or rejection of an enhanced media content item, according to certain aspects of the present disclosure. As illustrated, the user interface 300 includes a selectable option 310 to accept the application of the at least one enhancement to the captured media content item and a user selectable option 312 to reject the application of the at least one enhancement to the captured media content item. While not shown in FIG. 3, in aspects, the user interface 300 may include a selectable option to accept a portion of the at least one enhancement and reject a portion of the at least one enhancement.

Accept/reject module 130 may be configured to receive a selection of the user selectable option to accept the application of the at least one enhancement to the captured media content item. Upon receipt of the selection of the user selectable option to accept the application of the at least one enhancement to the captured media content item, the display module 128 further may be configured to cause display of the enhanced media content item in association with a user's account on the media sharing application.

Accept/reject module 130 further may be configured to receive a selection of the user selectable option to reject the application of the at least one enhancement to the captured media content item. Upon receipt of the selection of the user selectable option to reject the application of the at least one enhancement to the captured media content item, the display module 128 further may be configured to cause display of the captured media content item in association with a user's account on the media sharing application.

In aspects, accept/reject module 130 may be configured to receive a selection of a user selectable option to accept a portion of the at least one enhancement and reject a portion of the at least one enhancement.

In some implementations, computing platform(s) 110, remote platform(s) 112, and/or external resources 132 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 110, remote platform(s) 112, and/or external resources 132 may be operatively linked via some other communication media.

A given remote platform 112 may include one or more processors configured to execute computer program modules. The computer program modules may be configured to enable an expert or user associated with the given remote platform 112 to interface with system 100 and/or external resources 132, and/or provide other functionality attributed herein to remote platform(s) 112. By way of non-limiting example, a given remote platform 112 and/or a given computing platform 110 may include one or more of a server, a desktop computer, a laptop computer, a handheld computer, a tablet computing platform, a NetBook, a Smartphone, a gaming console, and/or other computing platforms.

External resources 132 may include sources of information outside of system 100, external entities participating with system 100, and/or other resources. In some implementations, some or all of the functionality attributed herein to external resources 132 may be provided by resources included in system 100.

Computing platform(s) 110 may include electronic storage 134, one or more processors 136, and/or other components. Computing platform(s) 110 may include communication lines, or ports to enable the exchange of information with a network and/or other computing platforms. Illustration of computing platform(s) 110 in FIG. 1 is not intended to be limiting. Computing platform(s) 110 may include a plurality of hardware, software, and/or firmware components operating together to provide the functionality attributed herein to computing platform(s) 110. For example, computing platform(s) 110 may be implemented by a cloud of computing platforms operating together as computing platform(s) 110.

Electronic storage 134 may comprise non-transitory storage media that electronically stores information. The electronic storage media of electronic storage 134 may include one or both of system storage that is provided integrally (i.e., substantially non-removable) with computing platform(s) 110 and/or removable storage that is removably connectable to computing platform(s) 110 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 136, information received from computing platform(s) 110, information received from remote platform(s) 112, and/or other information that enables computing platform(s) 110 to function as described herein.

Processor(s) 136 may be configured to provide information processing capabilities in computing platform(s) 110. As such, processor(s) 136 may include one or more of a digital processor, an analog processor, a digital circuit designed to process information, an analog circuit designed to process information, a state machine, and/or other mechanisms for electronically processing information. Although processor(s) 136 is shown in FIG. 1 as a single entity, this is for illustrative purposes only. In some implementations, processor(s) 136 may include a plurality of processing units. These processing units may be physically located within the same device, or processor(s) 136 may represent processing functionality of a plurality of devices operating in coordination. Processor(s) 136 may be configured to execute modules 118, 120, 122, 124, 126, 128, and/or 130, and/or other modules. Processor(s) 136 may be configured to execute modules 118, 120, 122, 124, 126, 128, and/or 130, and/or other modules by software; hardware; firmware; some combination of software, hardware, and/or firmware; and/or other mechanisms for configuring processing capabilities on processor(s) 136. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 118, 120, 122, 124, 126, 128, and/or 130 are illustrated in FIG. 1 as being within a single processing unit, in implementations in which processor(s) 136 includes multiple processing units, one or more of 118, 120, 122, 124, 126, 128, and/or 130 may be implemented remotely from the other modules. The description of the functionality provided by the different modules 118, 120, 122, 124, 126, 128, and/or 130 described below is for illustrative purposes, and is not intended to be limiting, as any of modules 118, 120, 122, 124, 126, 128, and/or 130may provide more or less functionality than is described. For example, one or more of modules 118, 120, 122, 124, 126, 128, and/or 130 may be eliminated, and some or all of its functionality may be provided by other ones of modules 118, 120, 122, 124, 126, 128, and/or 130. As another example, processor(s) 136 may be configured to execute one or more additional modules that may perform some or all of the functionality attributed below to one of modules 118, 120, 122, 124, 126, 128, and/or 130.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

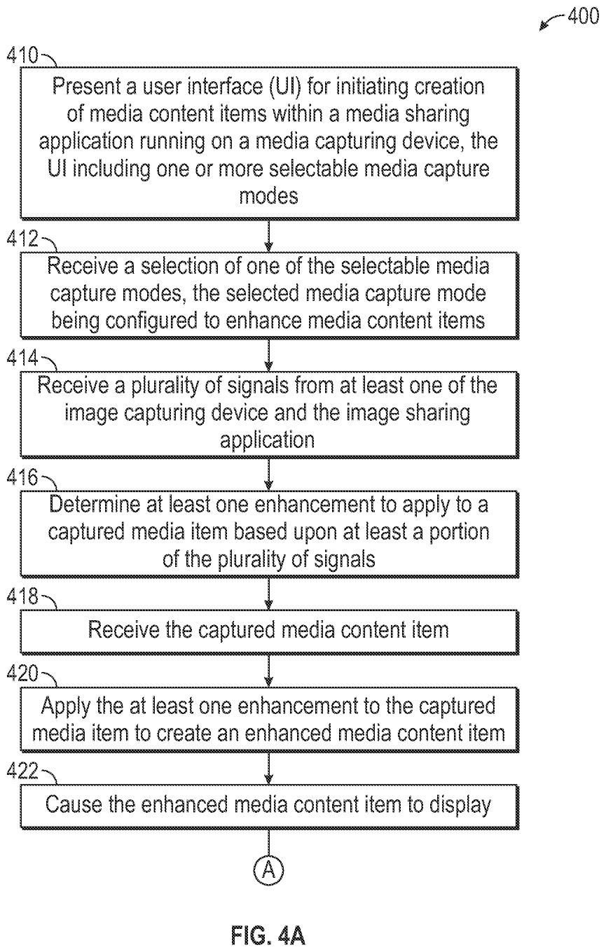

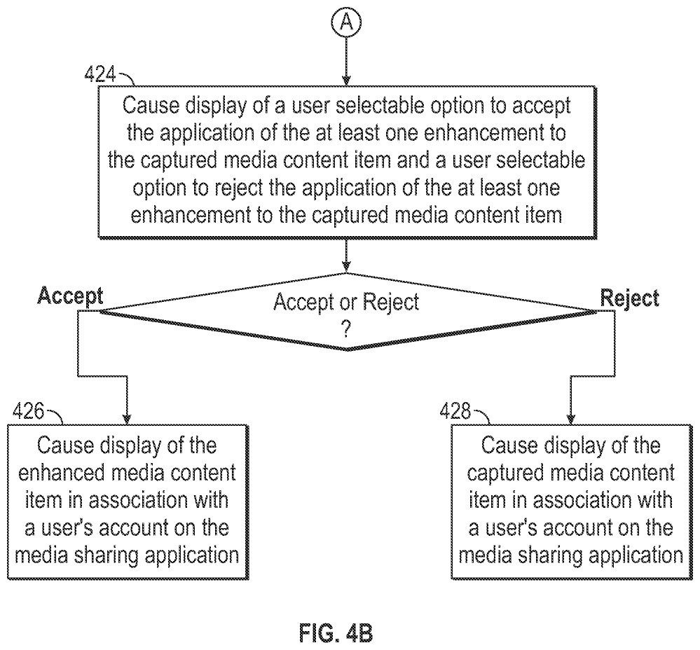

FIG. 4A illustrates an exemplary flow diagram (e.g., process 400) for intelligently enhancing media content items, according to certain aspects of the disclosure. For explanatory purposes, the exemplary process 400 is described herein with reference to FIGS. 1, 2, and 3. Further for explanatory purposes, the steps of the exemplary process 400 are described herein as occurring in serial, or linearly. However, multiple instances of the exemplary process 400 may occur in parallel.

At step 410, the process 400 may include presenting a user interface for intelligently enhancing media content items within a media sharing application running on a media capture device. In aspects, the user interface may be presented within a media sharing application running on a media capture device. In aspects, the user interface may include one or more selectable media capture modes. Exemplary media capture modes may include, without limitation, layout mode, multi-capture mode, boomerang mode, and the like. In aspects, at least one of the one or more selectable media capture modes may be configured to intelligently create enhanced media content items, a more fully described below.

At step 412, the process 400 may include receiving a selection of one of the one or more selectable media capture modes presented at step 410. In aspects, the one of the one or more selectable media capture modes may be configured to intelligently create enhanced media content items.

At step 414, the process 400 may include receiving a plurality of signals from at least one of the media capture device and the media sharing application. In aspects, one or more of the plurality of signals may be received from the media capture device. In aspects, the one or more of the plurality of signals received from the media capture device may include at least one of an ambient condition signal, a lighting condition signal, a location signal, and a time-of-day signal. In aspects, one or more of the plurality of signals may be received from the media sharing application. In aspects, the one or more of the plurality of signals received from the media sharing application may include at least one of a signal derived from user profile data, a signal derived from user social connection data, and a signal derived from a user social network news feed.

At step 416, the process 400 may include intelligently determining at least one enhancement to apply to a captured media content item based upon at least a portion of the plurality of signals. In aspects, the at least one enhancement may include application of a color filter to the captured media content item. In aspects, the at least one enhancement may include application of an effect to the captured media content item. In aspects, the at least one enhancement may include application of a digital sticker layered atop the captured media content item.

At step 418, the process 400 may include receiving the captured media content item. In aspects, the captured media content item may be received from a camera of the media capture device. In aspects, the captured media content item may be received from a camera of the media sharing application. In aspects, the captured media content item may be an image. In aspects, the captured media content item may be a video.

At step 420, the process 400 may include automatically (i.e., without user intervention or input) applying the at least one enhancement to the captured media content item to create an enhanced media content item. In aspects, the at least one enhancement may include application of a color filter to the captured media content item. In aspects, the at least one enhancement may include application of an effect to the captured media content item. In aspects, the at least one enhancement may include application of a digital sticker layered atop the captured media content item.

At step 422, the process 400 may include causing display of the enhanced media content item. In aspects, the enhanced media content item may be caused to be displayed in association with a media preview window of the media sharing application.

With reference now to FIG. 4B, illustrated is an exemplary flow diagram (e.g., process 400) for receiving acceptance or rejection of an intelligently enhanced media content item, according to certain aspects of the disclosure. For explanatory purposes, the exemplary process 400 is described herein with reference to FIGS. 1, 2, and 3. Further for explanatory purposes, the steps of the exemplary process 400 are described herein as occurring in serial, or linearly. However, multiple instances of the exemplary process 400 may occur in parallel.

According to an aspect, at step 424, the process 400 may include causing display of a user selectable option to accept the application of the at least one enhancement to the captured media content item and a user selectable option to reject the application of the at least one enhancement to the captured media content item.

According to an aspect, upon receiving a selection of the user selectable option to accept the application of the at least one enhancement to the captured media content item, at step 426, the process 400 may include causing display of the enhanced media content item in association with a user's account on the media sharing application.

According to an aspect, upon receiving a selection of the user selectable option to reject the application of the at least one enhancement to the captured media content item, at step 428, the process 400 may include causing display of the captured media content item in association with a user's account on the media sharing application.

For example, as described above in relation to FIGS. 1, 2, and 3, at step 410, the process 400 may include presenting (e.g., through user interface presenting module 316 of the system 300 of FIG. 3) a user interface (e.g., user interface 110 of FIG. 1) for creating media content items within a media sharing application running on a media capture device. The user interface may include one or more selectable media capture modes (e.g., selectable media capture modes 112 of FIG. 1). At step 412, the process 400 may include receiving (e.g., through media capture mode selection receiving module 318 of the system 300 of FIG. 3) a selection of one of the one or more selectable media capture modes presented at step 410. In aspects, the one of the one or more selectable media capture modes may be configured to intelligently enhance media content items (e.g., selectable media capture modes 112 of FIG. 1). At step 414, the process 400 may include receiving (e.g., through signal receiving module 320 of the system 300 of FIG. 3) a plurality of signals from at least one of the media capture device and the media sharing application. At step 416, the process 400 may include intelligently determining (e.g., through the enhancement determining module 322 of the system 300 of FIG. 3) at least one enhancement to apply to a captured media content item based upon at least a portion of the plurality of signals. At step 418, the process 400 may include receiving (e.g., through the captured media receiving module 324 of the system 300 of FIG. 3) the captured media content item. At step 420, the process 400 may include automatically applying (e.g., through the enhancement applying module 326 of the system 300 of FIG. 3) the at least one enhancement to the captured media content item to create an enhanced media content item. At step 422, the process 400 may include causing display of the enhanced media content item (e.g., through the display module 328 of the system 300 of FIG. 3).

According to an aspect, at step 424, the process 400 may include causing display (e.g., through the display module 328 of the system 300 of FIG. 3) of a user selectable option to accept the application of the at least one enhancement to the captured media content item (e.g., user selectable option 210 of FIG. 2) and a user selectable option to reject the application of the at least one enhancement to the captured media content item (e.g., user selectable option 212 of FIG. 2). According to an aspect, upon receiving a selection of the user selectable option to accept the application of the at least one enhancement to the captured media content item (e.g., through accept/reject module 330 of the system 300 of FIG. 3), at step 426, the process 400 may include causing display of the enhanced media content item in association with a user's account on the media sharing application (e.g., through the display module 328 of the system 300 of FIG. 3). According to an aspect, upon receiving a selection of the user selectable option to reject the application of the at least one enhancement to the captured media content item (e.g., through accept/reject module 330 of the system 300 of FIG. 3), at step 428, the process 400 may include causing display of the captured media content item in association with a user's account on the media sharing application (e.g., through the display module 328 of the system 300 of FIG. 3).

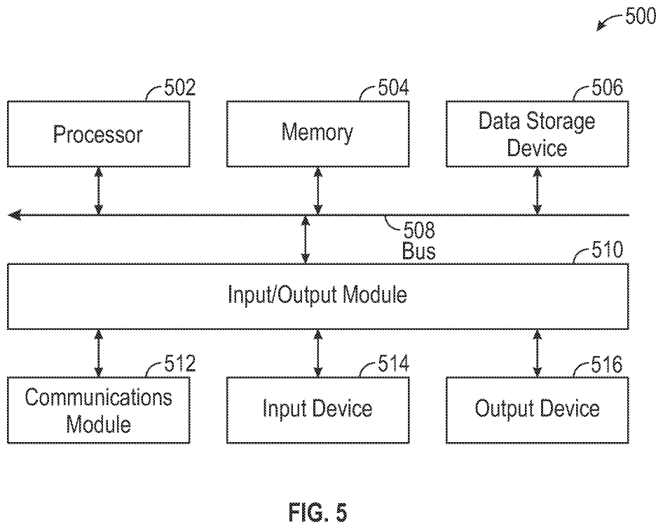

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as a LCD (liquid crystal display) monitor, for displaying information to the user.

According to one aspect of the present disclosure, the above-described systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads data, information may be read from the data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. A computer-implemented method for intelligently enhancing media content items, the method comprising:
presenting a user interface for initiating creation of media content items within a media sharing application running on a media capture device, the user interface including one or more selectable media capture modes;
receiving a selection of one of the one or more selectable media capture modes, the one of the one or more selectable media capture modes being configured to enhance the media content items;
receiving a plurality of signals from at least one of the media capture device and the media sharing application, the plurality of signals being independent of a captured media content item and the plurality of signals being indicative of one or more conditions external to the media capture device and the media sharing application;
determining at least one enhancement to apply to the captured media content item based upon at least a portion of the plurality of signals;
receiving the captured media content item;
automatically applying the at least one enhancement to the captured media content item to create an enhanced media content item; and
causing display of the enhanced media content item.

2. The computer-implemented method of claim 1, further comprising causing display of the enhanced media content item in a media preview window of the media sharing application.

3. The computer-implemented method of claim 1,
wherein one or more of the plurality of signals is received from the media capture device, and
wherein the one or more of the plurality of signals received from the media capture device includes at least one of an ambient condition signal, a lighting condition signal, a location signal, and a time-of-day signal.

4. The computer-implemented method of claim 1,
wherein one or more of the plurality of signals is received from the media sharing application, and
wherein the one or more of the plurality of signals received from the media sharing application includes at least one of a signal derived from user profile data, a signal derived from user social connection data, and a signal derived from a user social network news feed.

5. The computer-implemented method of claim 1, wherein the at least one enhancement applied to the captured media content item includes an application of a color filter to the captured media content item.

6. The computer-implemented method of claim 5, wherein the at least one enhancement applied to the captured media content item includes application of an effect to the captured media content item.

7. The computer-implemented method of claim 1, wherein the at least one enhancement applied to the captured media content item includes application of a digital sticker layered atop the captured media content item.

8. The computer-implemented method of claim 2, further comprising:
causing display of a user selectable option to accept the application of the at least one enhancement to the captured media content item and a user selectable option to reject the application of the at least one enhancement to the captured media content item.

9. The computer-implemented method of claim 8, further comprising:
receiving a selection of the user selectable option to accept the application of the at least one enhancement to the captured media content item; and
causing display of the enhanced media content item in association with a user's account on the media sharing application.

10. The computer-implemented method of claim 8, further comprising:
receiving a selection of the user selectable option to reject the application of the at least one enhancement to the captured media content item; and
causing display of the captured media content item in association with a user's account on the media sharing application.

11. A system configured for intelligently enhancing media content items, the system comprising:
one or more hardware processors configured by machine-readable instructions to:
present a user interface for initiating creation of media content items within a media sharing application running on a media capture device, the user interface including one or more selectable media capture modes;
receive a selection of one of the one or more selectable media capture modes, the one of the one or more selectable media capture modes being configured to enhance the media content items;
receive a plurality of signals from at least one of the media capture device and the media sharing application, the plurality of signals being independent of a captured media content item and the plurality of signals being indicative of one or more conditions external to the media capture device and the media sharing application;
determine at least one enhancement to apply to the captured media content item based upon at least a portion of the plurality of signals;
receive the captured media content item;
automatically apply the at least one enhancement to the captured media content item to create an enhanced media content item; and
cause display of the enhanced media content item in a media preview window of the media sharing application.

12. The system of claim 11,
wherein one or more of the plurality of signals is received from the media capture device, and
wherein the one or more of the plurality of signals received from the media capture device includes at least one of an ambient condition signal, a lighting condition signal, a location signal, and a time-of-day signal.

13. The system of claim 11,
wherein one or more of the plurality of signals is received from the media sharing application, and
wherein the one or more of the plurality of signals received from the media sharing application includes at least one of a signal derived from user profile data, a signal derived from user social connection data, and a signal derived from a user social network news feed.

14. The system of claim 11, wherein the at least one enhancement applied to the captured media content item includes an application of a color filter to the captured media content item.

15. The system of claim 11, wherein the at least one enhancement applied to the captured media content item includes application of an effect to the captured media content item.

16. The system of claim 11, wherein the at least one enhancement applied to the captured media content item includes application of a digital sticker layered atop the captured media content item.

17. A non-transient computer-readable storage medium having instructions embodied thereon, the instructions being executable by one or more processors to perform a method for intelligently enhancing media content items, the method comprising:
presenting a user interface for initiating creation of enhanced media content items within a media sharing application running on a media capture device, the user interface including one or more selectable media capture modes;
receiving a selection of one of the one or more selectable media capture modes, the one of the one or more selectable media capture modes being configured to create the enhanced media content items;
receiving a plurality of signals from at least one of the media capture device and the media sharing application, the plurality of signals being independent of a captured media content item and the plurality of signals being indicative of one or more conditions external to the media capture device and the media sharing application;
determining at least one enhancement to apply to the captured media content item based upon at least a portion of the plurality of signals;
receiving the captured media content item;
automatically applying the at least one enhancement to the captured media content item to create an enhanced media content item; and
causing display of the enhanced media content item in a media preview window of the media sharing application.

18. The computer-readable storage media of claim 17,
wherein one or more of the plurality of signals is received from the media capture device, and
wherein the one or more of the plurality of signals received from the media capture device includes at least one of an ambient condition signal, a lighting condition signal, a location signal, and a time-of-day signal.

19. The computer-implemented method of claim 1,
wherein one or more of the plurality of signals is received from the media sharing application, and
wherein the one or more of the plurality of signals received from the media sharing application includes at least one of a signal derived from user profile data, a signal derived from user social connection data, and a signal derived from a user social network news feed.

20. The computer-readable storage media of claim 17, wherein the at least one enhancement applied to the captured media content item includes one or more of an application of a color filter to the captured media content item, an application of an effect to the captured media content item, and an application of a digital sticker layered atop the captured media content item.
